(19) United States
(12) Patent Application Publication
(10) Pub. No.: US 2021/0004152 A1
(43) Pub. Date: Jan. 7, 2021

(54) ELECTRONIC APPARATUS

(71) Applicant: CANON KABUSHIKI KAISHA, Tokyo (JP)

(72) Inventors: Ryo Takahashi, Tokyo (JP); Tomoaki Takahashi, Isehara-shi (JP); Ryu Wakui, Tokyo (JP); Asami Takenaga, Tokyo (JP)

(21) Appl. No.: 16/917,133

(22) Filed: Jun. 30, 2020

(30) Foreign Application Priority Data
Jul. 2, 2019 (JP) 2019-123725
Mar. 17, 2020 (JP) 2020-045994

(51) Int. Cl. G06F 3/0488; G06T 13/80; G06F 3/0484

(52) U.S. Cl. CPC G06F 3/04883; G06T 2200/24; G06F 3/0484; G06T 13/80

(57) ABSTRACT

An electronic apparatus includes: an operation detection unit configured to detect an operation; and a display control unit configured to perform control so as to execute a first action to continuously change a display target when a specific type of operation is detected, execute a second action which is one of: an action to continuously change the display target at a higher speed than the first action; an action to change the display target by a predetermined amount; and an action to change the display target to a predetermined change destination, when a second type of operation is detected, and display a guidance for the second type of operation at the end of the specific type of operation in a case where the specific type of operation is detected and a predetermined condition is satisfied.

### BACKGROUND OF THE INVENTION

### Field of the Invention

The present invention relates to a technique to change a specific parameter (e.g. image to be displayed) in according with the operation.

### Description of the Related Art

A method of switching images to be displayed by an operation to input a position on an operation surface, such as a touch operation, has been available. Japanese Patent Application Publication No. 2013-175214 discloses that if dragging is performed after touching, a moving distance (change amount) of the frame to be displayed is changed in accordance with the dragging distance.

On the other hand, an electronic apparatus that notifies an efficient operation method, which is different from the operation performed by the user, was proposed. In Japanese Patent Application Publication No. 2007-4586, it is proposed that when the volume Down key is pressed for a long time, a message that the volume can be decreased to zero by inputting the mute key is displayed. It is also proposed that when a number of times of operation to generate an arbitrary action reaches a certain value, a different efficient operation method to generate the same action is notified.

In the case of using the method of Japanese Patent Application Publication No. 2013-175214, if an operation method that can more efficiently change the image to be displayed, instead of the drag operation, is available, and the user unaware of this, the user may repeat the drag operation and not efficiently change the image to be displayed. In the case of the method of Japanese Patent Application Publication No. 2007-4586, on the other hand, a different efficient operation method is notified if the same operation is repeated, but this guidance display may become unnecessary and irritable if the user is performing fine adjustment by repeating the detailed operation and does not intend to perform a major change, for example. This is also the same in the case where the target of change is other than the image to be displayed, or the volume. Further, in the case where the target of change is an image to be displayed, the image to be displayed may be interfered with by the guidance display depending on the timing, which makes the user experience irritation.

### SUMMARY OF THE INVENTION

With the foregoing in view, the present invention provides an electronic apparatus that can display the guidance to efficiently change the target of change at a more appropriate timing.

An electronic apparatus according to the present invention, includes at least one memory and at least one processor which function as: an operation detection unit configured to detect an operation on an operation member; and a display control unit configured to perform control so as to execute a first action to continuously change a display target displayed on a display when a specific type of operation on the operation member is detected, execute a second action which is one of an action to continuously change the display target at a higher speed than the first action; an action to change the display target by a predetermined amount larger than a change amount by a one-time execution of the first action; and an action to change the display target to a predetermined change destination, when a second type of operation on the operation member is detected, and display a guidance for the second type of operation at the end of the specific type of operation in a case where the specific type of operation is detected and a predetermined condition is satisfied.

Further features of the present invention will become apparent from the following description of exemplary embodiments with reference to the attached drawings.

### BRIEF DESCRIPTION OF THE DRAWINGS

FIG. 1A and FIG. 1B are external views of a digital camera 100:

FIG. 2 is a block diagram of the digital camera 100;

FIG. 3A to FIG. 3D are diagrams depicting states of image switching;

FIG. 4A and FIG. 4B are diagrams depicting a configuration of a touch bar 82;

FIG. 5 is a flow chart depicting a reproduction mode processing according to Embodiment 1;

FIG. 6 is a flow chart depicting a Touch-Up processing according to Embodiment 1;

FIG. 7A to FIG. 7C are diagrams depicting states of displaying a function guidance;

FIG. 8 is a flow chart depicting a reproduction mode processing according to Embodiment 2;

FIG. 9 is a flow chart depicting a Touch-Up processing according to Embodiment 2; and

FIG. 10 is a flow chart depicting a Touch-Up processing according to Embodiment 3.

### DESCRIPTION OF THE EMBODIMENTS

External View of Digital Camera 100

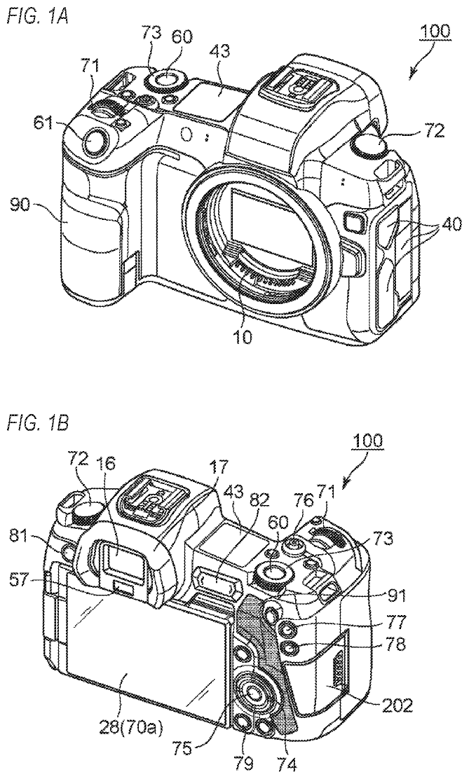

Preferred embodiments of the present invention will be described with reference to the drawings. FIG. 1A and FIG. 1B are external views of a digital camera 100, which is an example of an apparatus to which the present invention is applicable. FIG. 1A is a front perspective view of the digital camera 100, and FIG. B is a rear perspective view of the digital camera 100.

A display unit 28 is a display unit disposed on the rear surface of the digital camera 100, and displays images and various information. A touch panel 70a detects the touch operation performed on the display surface (touch operation surface) of the display unit 28. An outer finder display unit 43 is a display unit disposed on the upper surface of the digital camera 100, and displays various set values of the digital camera 100, such as the shutter speed and aperture. A shutter button 61 is an operation member to instruct to capture an image. A mode selection switch 60 is an operation member to switch between various modes. Terminal covers 40 are covers to protect connectors (not illustrated) for a connection cable or the like, which connect the digital camera 100 to an externa apparatus.

A main electronic dial 71 is a rotational operation member, and such set values as the shutter speed and aperture can be changed by turning the main electronic dial 71. A power switch 72 is an operation member to switch the power supply of the digital camera 100 ON/OFF. A sub-electronic dial 73 is a rotational operation member, and movement of a selection frame (cursor) and image switching, for example, can be performed by turning the sub-electronic dial 73. A four-direction key 74 is configured such that the upper part, lower part, left part and right part of the key can be pressed respectively, so that the processing corresponding to the pressed part of the four-direction key 74 can be performed. A SET button 75 is a push button, and is mainly used to determine a selected item.

A video button 76 is used to start or stop video shooting (recording). An AE lock button 77 is a push button, and the exposure state can be fixed by pressing the AE lock button 77 in the image capturing standby state. A magnifying button 78 is an operation button to switch the magnifying mode ON/OFF in a live view display (LV display) of the image capturing mode. If the main electronic dial 71 is operated after setting the magnifying mode to ON, the live vie image (LV image) can be magnified or demagnified. In a reproduction mode, the magnifying button 78 functions as an operation button to magnify the reproduced image or to increase the magnification ratio. A reproduction button 79 is an operation button to switch between the image capturing mode and the reproduction mode. If the reproduction button 79 is pressed in the image capturing mode, the mode changes to the reproduction mode, in which the latest image, out of the images recorded in a recording medium 200 (described later), can be displayed on the display unit 28. A menu button 81 is a push button that is used to instruct to display a menu screen, and if the menu button 81 is pressed, the menu screen, that allows various settings, is displayed on the display unit 28. The user can intuitively perform various settings using the menu screen displayed on the display unit 28, the four-direction key 74 and the SET button 75.

A touch bar 82 (multifunction bar: M-Fn bar) is a linear-shaped touch operation member (line touch sensor) that can accept a touch operation. The touch bar 82 is disposed at a position that can be operated by touching (touchable) by using a thumb of the right hand, which is holding a grip 90 in a normal gripping manner (gripping manner recommended by the manufacturer). The touch bar 82 is an accepting unit that can accept such an operation as a tap operation on the touch bar 82 (operation of releasing within a predetermined period after touching without moving the touch position) and a slide operation to the left or right (operation of moving the touch position in the touched state after touching). The touch bar 82 is an operation member that is separate from the touch panel 70a, and has no display function.

A communication terminal 10 is a communication terminal for the digital camera 100 to communicate with a lens unit 150 (detachable, described later). An eye piece 16 is an eye piece portion of an eye piece finder 17 (peep type finder), and the user can view an image displayed on an EVF 29 (described later) via the eye piece 16. An eye contact detection unit 57 is an eye contact detection sensor to detect whether an eye of the user (image capturing individual) is contacting the eye piece 16. A cover 202 is a cover of a slot to store a recording medium 200 (described later). The grip 90 is a holding unit having such a shape that the user can easily hold the digital camera 100 with their right hand to capture images. When the user holds the digital camera 100 by gripping the grip 90 with their little finger, ring finger and middle finger, the shutter button 61 and the main electronic dial 71 are in positions that can be operated by the index finger of the right hand. In this state, the sub-electronic dial 73 and the touch bar 82 are in positions that can be operated by the thumb of the right hand. A thumb rest 91 (thumb standby position) is a grip member that is disposed on the rear surface side of the digital camera 100, in a location where the thumb of the right hand, which is holding the grip 90, can easily rest when no operation member is being operated. The thumb rest 91 is constituted of a rubber member or the like to enhance the holding force (sensation of gripping).

Configuration Block Diagram of Digital Camera 100

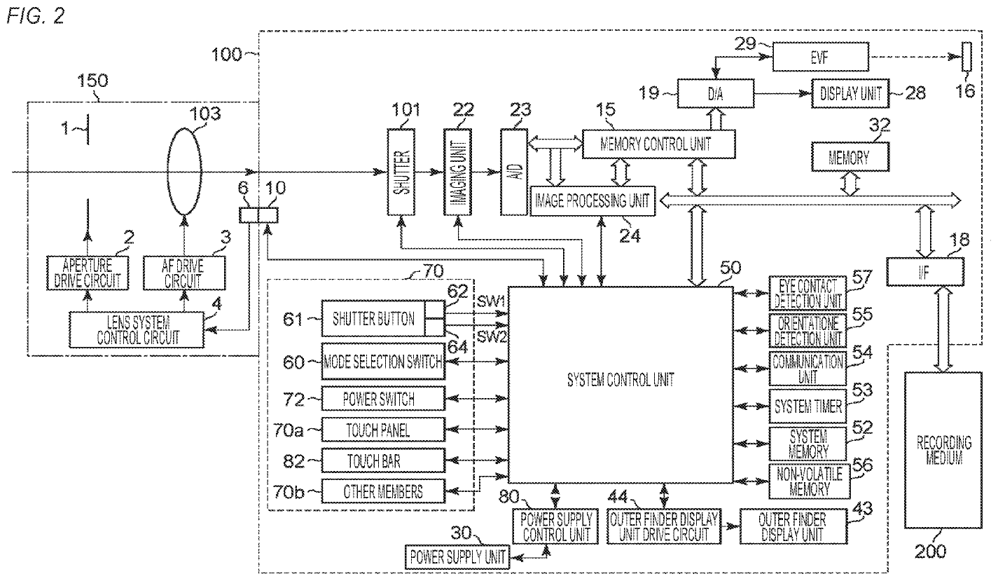

FIG. 2 is a block diagram depicting a configuration example of the digital camera 100. A lens unit 150 is a lens unit equipped with a replaceable image capturing lens. A lens 103 is normally constituted of a plurality of lenses, but is illustrated as one lens in FIG. 2 for simplification. A communication terminal 6 is a communication terminal for the lens unit 150 to communicate with the digital camera 100, and a communication terminal 10 is a communication terminal for the digital camera 100 to communicate with the lens unit 150. The lens unit 150 communicates with a system control unit 50 via these communication terminals 6 and 10. Then the lens unit 150 controls an aperture 1 via an aperture drive circuit 2, using an internal lens system control circuit 4. The lens unit 150 also performs focusing by moving the lens 103 via an AF drive circuit 3 using a lens system control circuit 4.

A shutter 101 is a focal plane shutter that can freely control the exposure time of an imaging unit 22 based on the control by the system control unit 50.

The imaging unit 22 is an image pickup element constituted of a CCD, a CMOS element or the like, to convert an optical image into electric signals. The imaging unit 22 may include an imaging plane phase difference sensor which outputs defocus amount information to the system control unit 50. An A/D convertor 23 converts analog signals outputted from the imaging unit 22 into digital signals.

An image processing unit 24 performs a predetermined processing (e.g. pixel interpolation, resizing such as demagnification, color conversion processing) on the data from the A/D convertor 23 or the data from a memory control unit 15. The image processing unit 24 also performs a predetermined arithmetic processing using the captured image data, and the system control unit 50 performs exposure control and distance measurement control based on the arithmetic result acquired by the image processing unit 24. Thereby through-the-lens (TTL) type autofocus (AF) processing, auto exposure (AE) processing, pre-flash emission (EF) processing and the like are performed. Furthermore, the image processing unit 24 performs a predetermined arithmetic processing using the captured image data, and performs TTL type auto white balance (AWB) processing based on the acquired arithmetic result.

The output data from the AD convertor 23 is written to the memory 32 via the image processing unit 24 and the memory control unit 15. In some cases, the output data from the A/D convertor 23 is written to the memory 32 via the memory control unit 15 without using the image processing unit 24. The memory 32 stores image data which was acquired by the imaging unit 22 and converted into digital data by the A/D convertor 23, and stores image data to be displayed on a display unit 28 or an EVF 29. The memory 32 has a storage capacity that is sufficient to store a predetermined number of still images and a predetermined duration of moving images and sounds.

The memory 32 is also a memory for image display (video memory). A DA convertor 19 converts the data for image display stored in the memory 32 into analog signals, and supplies the analog signals to the display unit 28 or the EVF 29. Thus the image data for display written in the memory 32 is displayed on the display unit 28 or the EVF 29 via the D/A convertor 19. The display unit 28 and the EVF 29 perform display in accordance with the analog signal from the D/A convertor 19 respectively, on such a display as an LCD and an organic EL. If digital signals, which were converted by the A/D convertor 23 and stored in the memory 32, are converted into analog signals by the D/A convertor 19 and sequentially transferred to and displayed on the display unit 28 or the EVF 29, live view display (LV) can be performed. An image displayed by the live view display is referred to as a live view image (LV image) herein below.

On the outer finder display unit 43, various set values of the camera, such as the shutter speed and aperture, are displayed via an outer finder display unit drive circuit 44.

A non-volatile memory 56 is a memory which is electrically erasable and recordable, such as EEPROM. In the non-volatile memory 56, constants and programs for actions of the system control unit 50, for example, are recorded. “Programs” here refers to the programs for executing various flow charts, which will be described later in the embodiments.

The system control unit 50 is a control unit constituted of at least one processor or circuit, and controls the digital camera 100 in general. The system control unit 50 implements each processing of the embodiments (described later) by executing the programs recorded in the above mentioned non-volatile memory 56. A system memory 52 is a RAM, for example, and the system control unit 50 develops, in the system memory 52, the constants and variables for actions of the system control unit 50, and the programs read from the non-volatile memory 56. The system control unit 50 also controls display by controlling the memory 32, the D/A convertor 19, the display unit 28 and the like.

The system timer 53 is a clock unit that measures the time used for various controls, and the time of the internal clock.

A power supply control unit 80 is constituted of a battery detect circuit, a DC-DC convertor, and switch circuits to switch to a block to be energized, and detects whether a battery is installed, the type of battery, and the residual amount of battery power, for example. The power supply control unit 80 also controls the DC-DC convertor based on the detection result and the instructions of the system control unit 50, and supplies the required voltage to each unit, including the recording medium 200, for a required period of time. A power supply unit 30 is constituted of a primary battery (e.g. alkali battery, lithium battery), a secondary battery (e.g. NiCd battery, NiNH battery, Li battery), an AC adapter and the like.

A recording medium IF 18 is an interface with the recording medium 200 (e.g. memory card, hard disk). The recording medium 200 is a recording medium to record captured images, such as a memory card, and is constituted of a semiconductor memory, a magnetic disk or the like.

A communication unit 54 transmits/receives video signal and sound signals to/from an external apparatus connected wirelessly or via cable. The communication unit 54 can also be connected with a wireless local area network (LAN) and the Internet. The communication unit 54 can also communicate with an external apparatus via Bluetooth® or Bluetooth Low Energy. The communication unit 54 can transmit an image (including an LV image) captured by the imaging unit 22 and an image recorded in the recording medium 200, and can receive image data and various other information from an external apparatus.

An orientation detection unit 55 detects an orientation of the digital camera 100 with respect to the direction of gravity. Based on the orientation detected by the orientation detection unit 55, it can be determined whether an image captured by the imaging unit 22 is an image captured by the digital camera 100 held horizontally, or an image captured by the digital camera 100 held vertically. The system control unit 50 can attach the orientation information in accordance with the orientation detected by the orientation detection unit 55 to an image file of an image captured by the imaging unit 22, or can rotate and record the image. For the orientation detection unit 55, an acceleration sensor, a gyro sensor or the like can be used. The motion of the digital camera 100 (e.g. pan, tilt, lift, still) can be detected using the acceleration sensor or gyro sensor of the orientation detection unit 55.

The eye contact detection unit 57 detects the approach (contact) and the withdrawal (release) of an eye (object) to/from the eye piece 16 of the eye piece finder 17 (hereafter “finder”). The system control unit 50 switches the display unit 28 and the EVF 29 between the display (display state) and the non-display (non-display state) in accordance with the state detected by the eye contact detection unit 57. In concrete terms, in the case where the state is at least the image capturing standby state and the display destination is set to automatic switching, the display destination is the display unit 28 (display is ON) and the EVF 29 is set to non-display during the non-eye contact state. In the eye contact state, on the other hand, the display destination is the EVF 29 (display is ON) and the display unit 28 is set to non-display. For the eye contact detection unit 57, an infrared proximity sensor, for example, can be used, so as to detect the approach of an object to the eye piece 16 of the finder 17 which includes the EVF 29. When an object approaches, the infrared light emitted from a light-emitting unit (not illustrated) of the eye contact detection unit 57 is reflected by the object, and is received by a light-receiving unit (not illustrated) of the infrared proximity sensor. By the amount of the received infrared light, the distance of the object to the eye piece 16 (eye piece distance) can be determined. In this way, the eye contact detection unit 57 detects eye contact by detecting the proximity distance of the object to the eye piece 16. If an object that approaches the eye piece 16 within a predetermined distance is detected in the non-eye contact state (non-approaching state), it is determined that the eye contacted the eye piece 16. If an object of which approach was detected moved away by more than a predetermined distance in the eye contact state (approaching state), it is determined that the eye was withdrawn. The threshold to detect the eye contact and the threshold to detect the eye withdrawal may be differentiated by hysteresis, for example. After eye contact is detected, it is assumed that the eye contact state continues until the eye withdrawal is detected. After eye withdrawal is detected, it is assumed that the non-eye contact state continues until the eye contact is detected. The infrared proximity sensor is merely an example, and another type of sensor may be used for the eye contact detection unit 57 as long as the sensor can detect the approach of an eye or an object that can be used to determine eye contact.

The operation unit 70 is an input unit that receives operation performed by the user (user operation), and is used to input various action instructions to the system control unit 50. As illustrated in FIG. 2, the operation unit 70 includes the mode selection switch 60, the shutter button 61, the power switch 72, the touch panel 70a and the touch bar 82. The operation unit 70 also includes other operation members 70b, such as the main electronic dial 71, the sub-electronic dial 73, the four-direction key 74, the SET button 75, the video button 76, the AE lock button 77, the magnifying button 78, the reproduction button 79 and the menu button 81.

The mode selection switch 60 switches the action mode of the system control unit 50 to the still image capturing mode, the moving image capturing mode or the reproduction mode, for example. The modes included in the still image capturing mode are: auto image capturing mode, auto scene determination mode, manual mode, aperture priority mode (Av mode), shutter speed priority mode (Tv mode) and program AE mode (P mode). Various scene modes and custom modes, to perform image capturing settings for each image capturing scene, are also included. Using the mode selection switch 60, the user can directly select any one of these modes. The user may also select an image capturing mode list screen using the mode selection switch 60 first, then select any one of the plurality of modes displayed on the list using another operation member. In the same manner, a plurality of modes may be included in the moving image capturing mode.

The shutter button 61 includes a first shutter switch 62 and a second shutter switch 64. The first shutter switch 62 is turned ON in mid-operation of the shutter button 61, that is, in the half-depressed state (image capturing preparation instruction), and generates a first shutter switch signal SW1. By the first shutter switch signal SW1, the system control unit 50 starts an image capturing preparation action, such as auto focus (AF) processing, auto exposure (AE) processing, auto white balance (AWB) processing and pre-flash emission (EF) processing. The second shutter switch 64 is turned ON when the operation of the shutter button 61 completes, that is, in the fully-depressed state (image capturing instruction), and generates a second shutter switch signal SW2. By the second shutter switch signal SW2, the system control unit 50 starts a series of actions of the image capturing processing, from reading signals from the imaging unit 22 to writing the captured image to the recording medium 200, as an image file.

The touch panel 70a and the display unit 28 can be integrated. For example, the touch panel 70a is configured so that the transmittance of the light does not interfere with the display on the display unit 28, and is superimposed on the upper layer of the display surface of the display unit 28. Then the input coordinates on the touch panel 70a are corresponded with the display coordinates on the display surface of the display unit 28. Thereby a graphic user interface (GUI), which allows the user to directly operate the screen displayed on the display unit 28, can be provided. The system control unit 50 can detect the following operations on the touch panel 70a or the state thereof
A finger or pen which is not touching the touch panel 70a touches the touch panel 70a, that is, touch is started (hereafter Touch-Down)
A finger or pen is touching the touch panel 70a (hereafter Touch-On)
A finger or pen is moving in the state of touching the touch panel 70a (hereafter Touch-Move)
A finger or pen, which is touching the touch panel 70a, is released from the touch panel 70a, that is, touch is ended (hereafter Touch-Up)
Nothing is touching the touch panel 70a (hereafter Touch-Off)

When Touch-Down is detected, Touch-On is also detected at the same time. Unless Touch-Up is detected after Touch-Down, Touch-On is normally detected continuously. When Touch-Move is detected as well, Touch-On is detected at the same time. Even if Touch-On is detected, Touch-Move is not detected unless the touch position is moving. Touch-Off is detected when Touch-Up of all fingers or pen is detected.

These operations, states and coordinates of the positions of the fingers or pen touching the touch panel 70a are notified to the system control unit 50 via the internal bus. Then based on the notified information, the system control unit 50 determines the kind of operation (touch operation) that was performed on the touch panel 70a. For Touch-Move, the system control unit 50 can also determine the moving direction of the fingers or pen moving on the touch panel 70a, based on the change of the positional coordinates, for the vertical components and the horizontal components on the touch panel 70a respectively. If Touch-Move is detected for at least a predetermined distance, the system control unit 50 determines that the slide operation was performed. An operation of quickly moving a finger on the touch panel 70a for a certain distance in the touched state and released the finger is called “flick”. In other words, flick is an operation of moving and releasing the finger rapidly on the touch panel 70a. If Touch-Move is detected for at least a predetermined distance at a predetermined speed or faster, and Touch-Up is detected thereafter, the system control unit 50 then determines that flick was performed (determines that flick was performed after the slide operation). Further, a touch operation of touching a plurality of points (e.g. two points) simultaneously (multi-touch) and moving these touch positions closer together is called “Pinch-in”, and a touch operation of moving these touch positions further apart is called “Pinch-Out”. Pinch-In and Pinch-Out are collectively called a pinch operation (or simply “pinch”). For the touch panel 70a, various types of touch panels may be used, such as a resistive film type, a capacitive type, a surface acoustic wave type, an infrared type, an electromagnetic induction type, an image recognition type and an optical sensor type. There is a type of detecting a touch when the touch panel is actually contacted, and a type of detecting a touch when a finger or pen approaches the touch panel, but either type may be used.

The system control unit 50 can also detect the following operations on the touch bar 82 or the state thereof.
A finger which is not touching the touch bar 82 touches the touch bar 82, that is, touch is started (hereafter Touch-Down)
A finger is touching the touch bar 82 (hereafter Touch-On)
A finger is moving in the state of touching the touch bar 82 (hereafter Touch-Move)
A finger, which is touching the touch bar 82, is released from the touch bar 82, that is, touch is ended (hereafter Touch-Up)
Nothing is touching the touch bar 82 (hereafter Touch-Off)

When Touch-Down is detected, Touch-On is also detected at the same time. Unless Touch-Up is detected after Touch-Down, Touch-On is normally detected continuously. When Touch-Move is detected as well, Touch-On is detected at the same time. Even if Touch-On is detected, Touch-Move is not detected unless the touch position is moving. Touch-Off is detected when Touch-Up of all fingers or pen is detected.

These operations, states and coordinates of the position of the finger touching the touch bar 82 are notified to the system control unit 50 via the internal bus, and based on the notified information, the system control unit 50 determines the kind of operation (touch operation) that was performed on the touch bar 82. For Touch-Move, the system control unit 50 detects the moving of the finger on the touch bar 82 in the horizontal direction (lateral direction). If it is detected that the touch position moved for at least a predetermined distance (moved for at least a predetermined amount), the system control unit 50 determines that the slide operation was performed. If a finger which touches the touch bar 82 is released from the touch bar 82 within a predetermined time without the sliding operation, the system control unit 50 determines that a tap operation was performed. The touch bar 82 is assumed to be a capacitive type touch sensor in this embodiment. However, the touch sensor may be a different type of touch sensor, such as a resistive film type, a surface acoustic wave type, an infrared type, an electromagnetic induction type, an image recognition type and an optical sensor type.

The system control unit 50 can also detect Touch-Hold on the touch bar 82 (a finger touches the touch bar 82, and continuously touches the touch bar 82 for a longer time than a predetermined time without the slide operation, which is an operation that continuously pushes the touch bar 82 by a finger).

### Embodiment 1

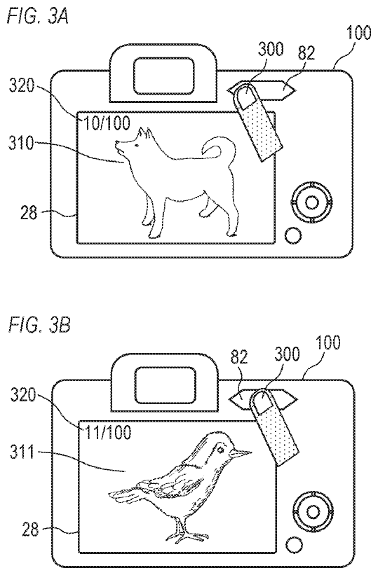

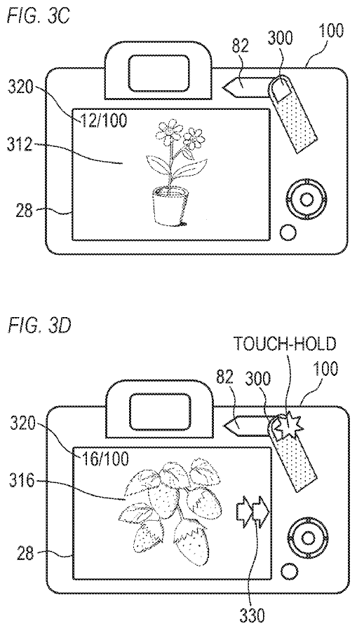

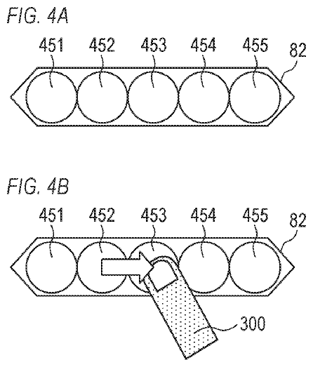

Embodiment 1 will be described using the above mentioned hardware configuration. In Embodiment 1, image switching (this is an action to switch the display target image among a plurality of images; the change target is an image, and the image to be displayed is changed by this operation) using the touch bar 82 is performed. FIG. 3A to FIG. 3D indicate an example of the state of image switching, and FIG. 4A and FIG. 4B indicate a configuration example of the touch bar 82. An overview of image switching using the touch bar 82 will be described with reference to FIG. 3A to FIG. 3D, FIG. 4A and FIG. 4B.

FIG. 3A indicates a state before image switching is performed. In FIG. 3A, an image 310 and an image number information 320 are displayed on the display unit 28. The image number information 320 indicates that a total number of images stored in the recording medium 200 is 100, and the currently displayed image 310 is the tenth image.

In Embodiment 1, it is assumed that the touch bar 82 has five detection points 451 to 455 (positions where touching the touch bar 82 is detected), as illustrated in FIG. 4A. FIG. 3A is a state where Touch-Down is performed at detection point 452 with a finger 300. As illustrated in FIG. 4B, if a slide operation (Touch-Move) in the right direction is performed by the finger 300 from the detection point 452 to the detection point 453, the state in FIG. 3A changes to the state in FIG. 3B.

In FIG. 3B, the image displayed on the display unit 28 is updated from the image 310 to the next image 311 by the slide operation to the right direction, and the image number information 320 is updated to indicate that the currently displayed image is the eleventh image.

As described above, in Embodiment 1, the display target image can be switched to the next image (forward direction) by performing the slide operation on the touch bar 82 in the right direction (plus direction). Further, the display target image can be switched to the previous image (backward direction) by performing the slide operation on the touch bar 82 in the left direction. For example, if Touch-Down is performed at the detection point 452 and the slide operation to the detection point 451 is performed, then the display target image is switched from the tenth image 310 to the ninth image.

If Touch-Up is performed at the detection point 453, image switching ends in the state where only one image was advanced (FIG. 3B). However, if the slide operation in the plus direction is continued until the detection point 454 without performing Touch-Up, the display target image is switched to the twelfth image 312, as illustrated in FIG. 3C. A number of images to be switched increases as the operation amount of the slide operation (moving distance of the touch position) is larger. The same is true for the slide operation in the minus direction. In Embodiment 1, one to four images can be switched by the slide operation among the five detection points 451 to 455.

By repeating the operations Touch-Down→Touch-Move (plus direction)→Touch-Up on the touch bar 82, many images can be switched in the forward direction. The same is true for the minus direction. However, repeating such operations many times may tire the user' fingers. Therefore in Embodiment 1, with the Touch-Hold (continuing Touch-On) operation, after Touch-Down→Touch-Move, the image switching in the direction the same as the direction of Touch-Move is continued (continuous image switching), so that an image can be easily switched forward or backward for several images. FIG. 3D indicates this state.

FIG. 3D indicates a state where continuous image switching in the forward direction is being performed by Touch-Hold after the slide operation in the plus direction. In FIG. 3D, the image displayed on the display unit 28 has been updated to the sixteenth image 316 by the continuous image switching in the forward direction, and the image number information 320 has been updated so that the currently displayed image is the sixteenth image. Further, a continuous image switching guide 330 is displayed on the display unit 28, in order to notify the user that the image switching is continuing and that the direction of continuous image switching is forward, or in order to distinguish the continuous image switching from an image switching in accordance with the slide operation. In the same manner, when the Touch-Hold is performed after the slide operation in the minus direction, the image switching in the backward direction continues, and the continuous image switching guide is displayed in order to notify the user that the image switching in a direction is continuing, and that the direction of continuous image switching is backward.

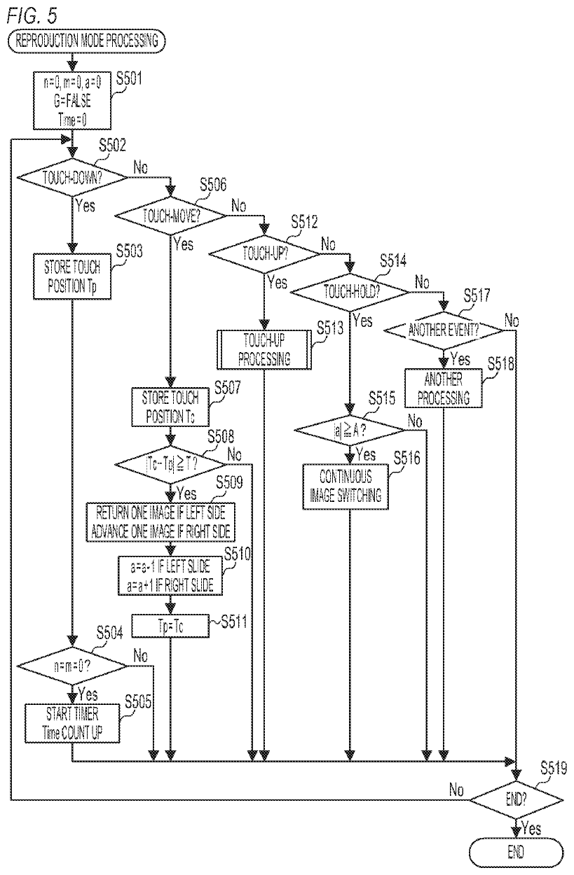

FIG. 5 is a flow chart depicting details of the reproduction mode processing performed by the digital camera 100 in Embodiment 1. This processing is implemented by the system control unit 50 developing a program which is recorded in the non-volatile memory 56, in the system memory 52, and executing the program. When the reproduction mode is started by the reproduction button 79, one of a plurality of images recorded in the recording medium 200 is displayed on the display unit 28, and the processing in FIG. 5 is started.

In S501, the system control unit 50 initializes various parameters that are used in the reproduction mode. In concrete terms, 0 is set to the count values n and m, which indicate a number of times of switching at least a predetermined number of images by the slide operation on the touch bar 82 from Touch-Down to Touch-Up. 0 is also set to the count value a, which indicates a number of images switched by the slide operation on the touch bar 82 from Touch-Down to Touch-Up. Further. FALSE, which indicates that the later mentioned function guidance is not displayed, is set to a flag Q which indicates whether the function guidance has already been displayed. Then 0 is set to the count time Time, which indicates the time elapsed from Touch-Down on the touch bar 82 at a predetermined timing (e.g. first Touch-Down) (this means that measurement of elapsed time is not started at this timing).

In S502, the system control unit 50 determines whether Touch-Down occurred on the touch bar 82, based on the output information of the touch bar 82. Processing advances to S503 if Touch-Down occurred, or to S506 is not.

In S503, the system control unit 50 stores the position Tp, at which Touch-Down occurred in S502, in the system memory 52. In the state in FIG. 3A, the position of the detection point 452 is stored in the system memory 52.

In S504, the system control unit 50 determines whether the count values n and m, which indicate a number of times of switching at least a predetermined number of images by the slide operation on the touch bar 82 from Touch-Down to Touch-Up therefrom, are 0. Processing advances to S505 if the count value n=m=0, or to S519 if not. If the count value m is 0, the count value n is also 0, as described in detail later. Therefore it may be determined only whether the count value m is 0 or not, without determining whether the count value n is 0 or not.

In S505, the system control unit 50 starts counting time so that the count value Time is sequentially counted up.

In S506, the system control unit 50 determines whether Touch-Move occurred on the touch bar 82 based on the output information of the touch bar 82. Processing advances to S507 if Touch-Move occurred, or to S512 if not.

In S507, the system control unit 50 stores the current touch position Tc (Touch-On position) on the touch bar 82 in the system memory 52.

In S508, the system control unit 50 determines whether the distance between the position Tc and the position Tp (that is, |Tc−Tp|) is at least a predetermined distance T in other words, whether the slide operation occurred on the touch bar 82. Processing advances to S509 if the distance between the position Tc and the position Tp is at least the predetermined distance T (if the slide operation occurred), or to S519 if not.

In S509, the system control unit 50 switches the display target image on the display unit 28 to the next image in the forward direction (advances one image) if the slide operation to the right (slide operation in the plus direction) occurred. Thereby the state in FIG. 3A switches to the state in FIG. 3B, for example. If the slide operation to the left (slide operation in the minus direction) occurred, the system control unit 50 switches the display target image to the previous image in the backward direction (returns to previous image).

In S510, if the slide operation to the right occurred (if the current image is switched to the next image in the forward direction), the system control unit 50 increments the count value a by 1, and if the slide operation to the left occurred (if the current image is switched to the previous image in the backward direction), the system control unit 50 decrements the count value a by 1. The count value a can be a positive value or a negative value, and the absolute value of the count value a corresponds to the number of images switched by the slide operation on the touch bar 82 from Touch-Down to Touch-Up.

In S511, the system control unit 50 updates the position Tp (variable) to the position Tc.

In S512, the system control unit 50 determines whether Touch-Up from the touch bar 82 occurred based on the output information from the touch bar 82. Processing advances to S513 if Touch-Up occurred, or to S514 if not.

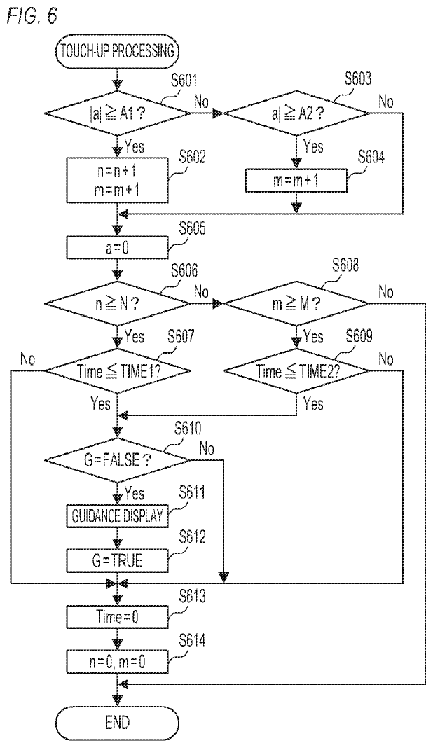

In S513, the system control unit 50 performs Touch-Up processing. Touch-Up processing will be described in detail later with reference to FIG. 6.

In S514, based on the output information from the touch bar 82, the system control unit 50 determines whether Touch-Hold on the touch bar 82 occurred. Processing advances to S515 if Touch-Hold occurred, or to S517 if not.

In S515, the system control unit 50 determines whether the absolute value of the count value a is at least a threshold A, that is, whether Touch-Hold in S514 occurred after at least A number of images were switched by the slide operation on the touch bar 82. Processing advances to S516 if the absolute value of the count value a is at least the threshold A, that is, if Touch-Hold in S514 occurred after advancing or returning at least A number of images by the slide operation, or to S519 if not. The threshold A is not especially restricted, and may be 2 (or 1), for example.

In S516, the system control unit 50 performs continuous image switching (action to sequentially switch the display target image among a plurality of images) in a direction in accordance with the direction of the slide operation which just occurred. If Touch-Hold occurred after executing image switching in the forward direction in accordance with the slide operation in the plus direction, the continuous image switching in the forward direction is performed, and if Touch-Hold occurred after executing image switching in the backward direction in accordance with the slide operation in the minus direction, the continuous image switching in the backward direction is performed. In the case of the continuous image switching in the forward direction, the display target image is switched to the next image as touching time elapses without the slide operation (first type of operation). For example, while touching is continuing without the slide operation after Touch-Hold (second type of operation) is determined, the display target image is switched to the next image every ¼ second. In the case of the continuous image switching in the backward direction, the display target image is switched to the previous image as touching time elapses without performing the slide operation. For example, while touch is continuing without the slide operation after Touch-Hold is determined, the display target image is switched to the previous image every ¼ second.

In S517, the system control unit 50 determines whether another event occurred. Processing advances to S518 if another event occurred, or to S519 if not. Another even is, for example, pressing the menu button 81.

In S518, the system control unit 50 processes the other event. For example, if the menu button 81 was pressed, the system control unit 50 displays the menu screen on the display unit 28.

In S519, the system control unit 50 determines whether the reproduction mode ends. The system control unit 50 ends the reproduction mode and shifts to another mode if the reproduction mode ends, or returns to S502 (enters event monitoring state) if not.

FIG. 6 is a flow chart depicting details of the Touch-Up processing (S513) performed by the digital camera 100. This processing is implemented by the system control unit 50 developing a program, which is recorded in the non-volatile memory 56, in the system memory 52, and executing the program.

In S601, the system control unit 50 determines whether the absolute value of the count value a is at least a threshold A1, that is, whether Touch-Up in S512 occurred after at least A1 number of images were switched by one slide operation on the touch bar 82. Processing advances to S602 if the absolute value of the count value a is at least the threshold A1, that is, if Touch-Up in S512 occurred after at least A1 number of images were switched by the slide operation, or to S603 if not. The threshold A1 is a value larger than the later mentioned threshold A2, and is 4, for example. Further, the threshold A1 is used to determine whether the operation amount is an amount that indicates a case when the user intends to change the target by a large change amount, and is a value larger than the minimum unit (1 in Embodiment 1) of the image switching amount (change amount), which the slide operation is capable of changing.

In S602, the system control unit 50 increments the count values n and m by 1.

In S603, the system control unit 50 determines whether the absolute value of the count value a is at least a threshold A2, that is, whether Touch-Up in S512 occurred after at least A2 number of images were switched by one slide operation on the touch bar 82. Processing advances to S604 if the absolute value of the count value a is at least the threshold A2, that is, if Touch-Up in S512 occurred after at least A2 number of images were switched by the slide operation, or to S605 if not. The threshold A2 is assumed to be smaller than the threshold A1 and larger than the minimum unit (1 in Embodiment 1) of the image switching amount (change amount), which the slide operation is capable of changing. In Embodiment 1, the threshold A2 is assumed to be 2. The threshold A2 may be the same as or different from the threshold A, which determines whether the continuous image switching is performed.

In S604, the system control unit 50 increments the count value m by 1.

As described above, if Touch-Up occurs after at least A1 number of images were switched by the slide operation, the count values n and m are incremented by 1 in S602. If Touch-Up occurs after at least A2 and less than A1 number of images were switched by the slide operation, the count value m is incremented by 1 (count value n is not incremented) in S604. Therefore the count value n indicates a number of times of switching at least A1 number of images by the slide operation from Touch-Down on the touch bar 82 to Touch-Up therefrom. The count value m, on the other hand, indicates a number of times of switching at least A2 number of images by the slide operation from Touch-Down on the touch bar 82 to Touch-Up therefrom.

In S605, the system control unit 50 initializes the count value a to 0, since Touch-Up occurred.

In S606, the system control unit 50 determines whether the count value n is at least a threshold N. Processing advances to S607 if the count value n is at least the threshold N, or to S608 if not. The threshold N is not especially restricted, and is 3, for example.

In S607, the system control unit 50 determines whether the count value Time (time elapsed from the timing in S505) is not more than a threshold TIME1.

Processing advances to S610 if the count value Time is not more than the threshold TIME1, or to S613 if not. The threshold TIME is not especially restricted, and is a value corresponding to 5 seconds, for example.

In S608, the system control unit 50 determines whether the count value m is at least a threshold M. Processing advances to S609 if the count value m is at least the threshold M, or Touch-Up processing ends if not. The threshold M is not especially restricted, except that it is larger than the threshold N, and is 8, for example.

In S609, the system control unit 50 determines whether the count value Time (time elapsed from the timing in S505) is not more than a threshold TIME2. Processing advances to S610 if the count value Time is not more than the threshold TIME2, or to S613 if not. The threshold TIME2 is not especially restricted, and is a value corresponding to 10 seconds, for example. (The value may be the same as or different from the threshold TIME1.) Since the threshold M is larger than the threshold N, it is more likely that the time required to make the count value m to be at least the threshold M is longer than the time required to make the count value n to be at least the threshold N. Therefore it is preferable that the threshold TIME2 is larger than the threshold TIME1.

In S610, the system control unit 50 determines whether FALSE (which indicates that function guidance is not displayed) is set to a flag Q which indicates whether the function guidance has already been displayed. Processing advances to S611 if flag G=FALSE, or to S613 if not.

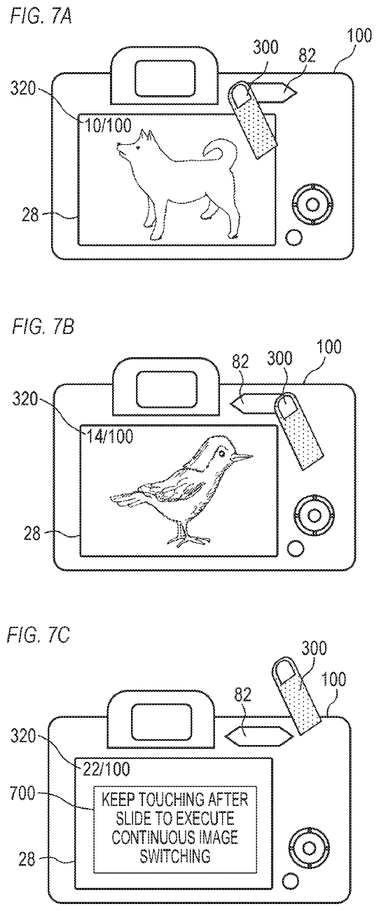

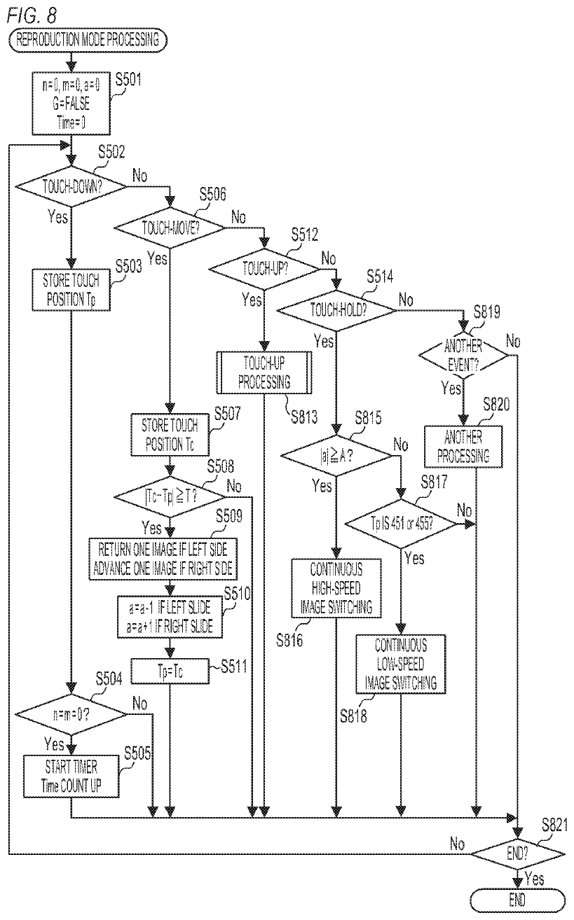

In S611, the system control unit 50 displays the function guidance to notify that continuous image switching can be performed by Touch-Hold after the slide operation (later mentioned function guidance 700 in FIG. 7C) on the display unit 28.

In S612, the system control unit 50 sets TRUE (indicates that function guidance has already been displayed) to the flag G.

In S613, the system control unit 50 initializes the count value Time to 0.

In S614, the system control unit 50 initializes the count values n and m to 0.

A concrete example of the action of the flow charts in FIG. 5 and FIG. 6 (an example of states where the function guidance is displayed) will be described with reference to FIG. 7A to FIG. 7C. FIG. 7A indicates a state where Touch-Down on the touch bar 82 was performed, and FIG. 7B indicates a state when A1=4 have switched by the slide operation in the plus direction. If the operation of Touch-Down in FIG. 7A→slide operation in FIG. 7B→Touch-Up is repeated for N=3 times within 5 seconds (time corresponding to the threshold TIME1), the function guidance 700 is displayed at the center of the screen of the display unit 28, as illustrated in FIG. 7C. By using the function guidance 700, the user can easily recognize that continuous image switching can be performed by Touch-Hold after the slide operation.

As described above, according to the flow charts in FIG. 5 and FIG. 6, if the slide operation of which operation amount is larger than the first operation amount (A1) is repeated on the touch bar 82 for at least a predetermined number of times (N1), the function guidance is displayed. It is more likely that the user desiring to quickly view an image ahead by several images repeats the slide operation of which operation amount is relatively large. Therefore according to the flow charts in FIG. 5 and FIG. 6, the function guidance is displayed at an appropriate timing, so that the user, desiring to quickly view an image ahead by several images, can recognize another operation method (continuous image switching) which allows to switch images at a larger change amount using a more efficient function. Furthermore, according to the flow charts in FIG. 5 and FIG. 6, the function guidance is not displayed even if an operation of which operation amount does not reach the first operation amount (A1) and the second operation amount (A2) is repeated. Therefore an unnecessary display of the function guidance (e.g. a case where the user' intention is to not quickly view an image ahead by several images) can be prevented. For example, display of the function guidance can be prevented in the case where the user does not desire to change images with a large change amount, such as the case of switching the current image one at a time until the target image is displayed, or the case of quickly switching the image one at a time to confirm the content of each image.

Even if the user desires to quickly view an image ahead by several images (desires to change at a large change amount), it is still possible that the user may not repeat the switching operation with a sufficiently large operation amount (at least A1), but repeat the switching operation with an operation amount that is smaller than A1 but larger than the minimum change amount. Even for such a user the function guidance, to guide the operation method to efficiently change the images with a large change amount, is displayed. In other words, in the case of the flow charts in FIG. 5 and FIG. 6, the function guidance is displayed if the slide operation, of which operation amount is at least the second operation amount (A2), is repeated on the touch bar 82 for at least M (>N) number of times, even if the operation amount of the slide operation is smaller than the first operation amount (A). However, S603. S604, S608 and S609 may be omitted so that the processing concerning the second operation amount (A2) is not performed, and the function guidance is not displayed regardless how many times the slide operation, of which operation amount is smaller than the first operation amount (A1), is repeated on the touch bar 82.

Furthermore, even if the slide operation, of which operation amount is large (at least A1), is repeated a plurality of times, it is likely that the user did not desire to view an image that is far ahead if the interval of each operation is long. Therefore in the flow charts in FIG. 5 and FIG. 6, the function guidance is displayed when the slide operation, of which operation amount reaches the predetermined operation amount (A1, A2), is repeated for at least the predetermined number of times (N, M) within the predetermined time (TIME1, TIME2). The function guidance is not displayed if the slide operation, of which operation amount is at least the predetermined operation amount, is not repeated for the predetermined number of times within the predetermined time (if the slide operation is not performed for the predetermined times within the predetermined period). Thereby an unnecessary display of the function guidance is further prevented, and the function guidance can be displayed at a more appropriate timing. However, S607 and S609 may be omitted so that the function guidance is displayed when the slide operation, of which operation amount is at least the predetermined operation amount, is performed on the touch bar 82 for at least the predetermined number of times, regardless whether this repeat was performed within the predetermined time or not.

Once the function guidance is displayed, it is more likely that the user will know this efficient function (continuous image switching), and display of the function guidance will be unnecessary thereafter. Hence in the flow charts in FIG. 5 and FIG. 6, after the function guidance is displayed, the function guidance is no longer displayed at least until the reproduction mode is exited, that is, until the screen to change the current change target ends, even if the slide operation, of which operation amount is larger than the predetermined operation amount (A1, A2), is performed on the touch bar 82 for more than the predetermined number of times (N, M). Thereby an unnecessary display of the function guidance is further prevented, and the function guidance can be displayed at a more appropriate timing. However, S610 may be omitted so that the function guidance is displayed if the slide operation, of which operation amount is larger than the predetermined operation amount, is repeated on the touch bar 82 for more than the predetermined number of times, even if this is after the function guide was previously displayed.

As described with reference to FIG. 3D, according to Embodiment 1, the continuous image switching guide 330 is displayed on the display unit 28 when the continuous image switching is executed. Unlike the function guidance 700 to notify that the continuous image switching is performed when Touch-Hold occurs after the slide operation, the continuous image switching guide 330 is an item that allows identifying that the continuous image switching is in-execution, and the direction of the continuous image switching and speed of the continuous image switching thereof. Thereby the user who instructed the continuous image switching after viewing the function guidance 700 can reconfirm that the operation method is correct (continuous image switching is in-execution).

An example of performing the continuous image switching (action of continuously changing the display target image) by Touch-Hold after the slide operation was described, but a different action (function) that can change the display target image more efficiently, (by a change amount larger than the maximum change amount which one slide operation can perform). For example, a predetermined number of (predetermined amount of) images may be switched (jumped) by Touch-Hold after the slide operation. For example, ten image-jumping, which switching the display target image to the tenth image ahead in each operation, or 100 image-jumping, which switching the display target image to the one hundredth image ahead in each operation, are possible. The display target image may be switched to a predetermined image (predetermined change destination) by Touch-Hold after the slide operation. For example, the currently reproducing moving image which includes chapter information, may switched to the lead position of the chapter. Further, date jumping may be performed by Touch-Hold after the slide operation, such as advancing the display target image to the first image of the images captured on the next image capturing date, or returning the display target image to the first image of the images captured on the same image capturing date. These actions allow switching the display target image to a desired image more efficiently than repeating one image switching (action of switching one image at a time). (In other words, the display target image can be changed by a change amount larger than that of a one-time slide operation).

An example of the touch operation on the touch bar 82 was described, but the image may be switched by a rotational operation using a rotational operation member (e.g. dial). For example, the function guidance may be displayed when the rotation operation, of which rotation amount is larger than a predetermined rotation amount, is performed for more than a predetermined number of times.

Further, an example of the image switching of which change target is an image to be displayed (processing to switch an image file of still images or moving images) was described, but the present invention can also be applied to the case of switching to a specific change target, of which quick change is desired by the user. For example, the present invention can be applied to cases of changing a frame to be displayed in one moving image, changing the sound volume, changing music to be reproduced, changing image capturing parameters (e.g. ISO sensitivity, shutter speed), and changing the image processing parameters (e.g. brightness adjustment value, color adjustment value). Furthermore, the present invention can be applied to the changing action to change various parameters, such as the date, time and seconds of the date and time setting, selection target of the address book, and page to be displayed in a document.

### Embodiment 2

In Embodiment 1, an example of displaying the function guidance when the slide operation, of which operation amount is larger than the first operation amount (A1), is repeated on the touch bar 82 for at least a predetermined number of times (N1) was described. In Embodiment 2, an example of displaying the function guidance at a timing when Touch-Up occurred after image switching is performed by Touch-Hold without the slide operation, will be described. In Embodiment 2, it is assumed that low-speed continuous image switching (continuous low-speed image switching) can be performed by Touch-Hold on the touch bar 82 without the slide operation, in addition to various touch operations on the touch bar 82 for image switching described in Embodiment 1. In concrete terms, the continuous low-speed image switching is performed when a specific type of touch operation is performed, when Touch-Down occurs to either the left or right edge of the touch bar 82, and Touch-Hold is detected without the slide operation. In other words, this specific type of operation is an operation of starting touch on a predetermined position of the operation surface of the touch bar 82, and continuing the touching state thereafter for at least a predetermined time without the slide operation. If the system control unit 50 detects Touch-Down on the left edge (Touch-Down to the detection point 451) and then detects Touch-Hold without the slide operation, the continuous low-speed image switching in the backward direction is performed. If the system control unit 50 detects Touch-Down on the right edge (Touch-Down to the detection point 455) and then detects Touch-Hold without the slide operation, the continuous low-speed image switching in the forward direction is performed. Just like Embodiment 1, continuous image switching is performed in accordance with Touch-Hold after Touch-Move (slide operation), but the image switching speed (image switching frequency) in this case is faster than the continuous low-speed image switching, hence this continuous image switching will be called “continuous high-speed image switching”. Touch-Hold after the slide operation is an operation of performing the slide operation after starting touch on the operation surface of the touch bar 82, and continuing touch without releasing for at last a predetermined time in the state of stopping sliding.

FIG. 8 is a flow chart depicting details of the reproduction mode processing performed by the digital camera 100 in Embodiment 2. The hardware configuration of the digital camera 100 is the same as that described with reference to FIGS. 1A, 1B, 2, 4A and 4B. This processing is implemented by the system control unit 50 developing a program, which is recorded in the non-volatile memory 56, in the system memory 52, and executing the program. When the reproduction mode is started by the reproduction button 79, one of a plurality of images recorded in the recording medium 200 is displayed on the display unit 28, and the processing in FIG. 8 is started.

In the processing in FIG. 8, a processing step the same as the above mentioned FIG. 5 is denoted with the same step number as FIG. 5, and description thereof is omitted. In Embodiment 2, the count values n, m and Time are not used. Therefore in S501, initialization of the count values n, m and Time is unnecessary, and processing may advance from steps S503 to S821, skipping the steps S504 and S505.

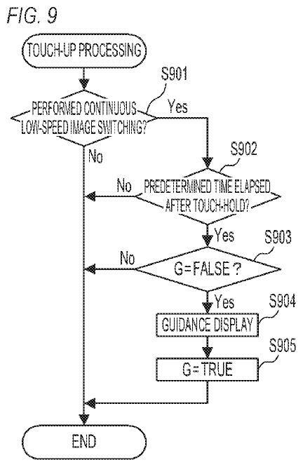

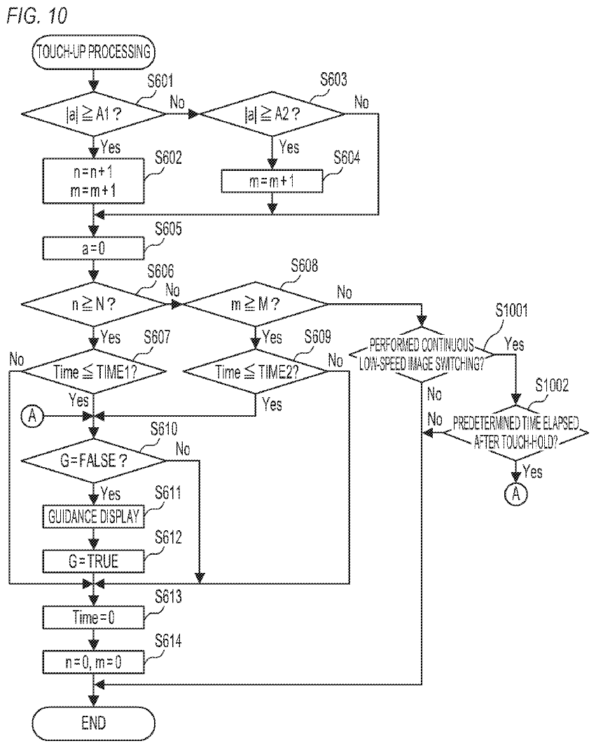

In S813, the system control unit 50 performs Touch-Up processing. The Touch-Up processing in S813 will be described later with reference to FIG. 9 or FIG. 10.

If it is determined that Touch-Hold (second type of operation) occurred in S514, processing advances to S815.

In S815, the system control unit 50 determines whether the absolute value of the count value a is at least the threshold A, that is, whether Touch-Hold in S514 occurred after an image is changed by the slide operation on the touch bar 82. Processing advances to S816 if the absolute value of the count value a is at least the threshold A, that is, if Touch-Hold in S514 occurred after at least A number of images were advanced or returned by the slide operation, or to S817 if not. The threshold A is assumed to be 1 in Embodiment 2. In the determination in S815, it may be determined whether Touch-Move (slide operation) occurred after Touch-Down on the touch bar 82, instead of determining whether the absolute value of the count value a is at least the threshold A. Processing advances to S816 if Touch-Hold occurred after Touch-Move (slide operation) was performed after Touch-Down. If Touch-Hold occurred without Touch-Move (slide operation) after Touch-Down, processing advances to S817.

In S816, the system control unit 50 performs continuous high-speed image switching (action to sequentially switch the display target image among a plurality of images) in a direction in accordance with the direction of the slide operation which just occurred. If Touch-Hold occurred after executing image switching in the forward direction in accordance with the slide operation in the plus direction, the continuous high-speed image switching in the forward direction is performed, and if Touch-Hold occurred after executing image switching in the backward direction in accordance with the slide operation in the minus direction, the continuous high-speed image switching in the backward direction is performed. In the case of the continuous high-speed image switching, the display target image is changed in accordance with the continuing time of Touch-Hold (time when touch continued after Touch-Hold without the slide operation). For example, in the case of the continuous high-speed image switching, the display target image is changed to the next image or the previous image every ¼ second while Touch-Hold continues.

In S817, the system control unit 50 determines whether or not the Touch-Down position is the left edge or the right edge of the touch bar 82, that is, whether or not the Touch-Down position is an edge in the slidable direction on the operation surface of the touch bar 82. In concrete terms, the system control unit 50 fetches the position Tp stored in the system memory 52, and determines whether the position Tp is the detection point 451 or the detection point 455. Processing advances to S818 if the position Tp is the detection point 451 or the detection point 455, or to S821 if not.

In S818, the system control unit 50 performs the continuous low-speed image switching (operation to sequentially switch the display target image among a plurality of images). The direction of the continuous low-speed image switching is the plus direction if the position Tp is the detection point 455, and the minus direction if the position Tp is the detection point 451. For example, if the position Tp is the detection point 455 and the touch on this position is continuing, the display target image is switched to the next image at a speed slower than the above mentioned continuous high-speed image switching, that is, every ½ second, for example. For the minus direction as well, if the position Tp is the detection point 451 and the touch on this position is continuing, the display target image is switched to the previous image every ½ second. If the continuous low-speed switching is performed in S818, the system control unit 50 stores the information that the continuous low-speed image switching was performed (continuous low-speed image switching execution completion flag) in the system memory 52. Even if Touch-Hold is performed by the touch operation without the slide operation, the continuous low-speed image switching is not executed and the continuous low-speed image switching execution completion flag is not recorded in the following cases.
In the case where only one display target image is recorded in the recording medium 200
in the case where Touch-Hold occurred at the detection point 451 when the image at the start point of the image sequence is displayed
in the case where Touch-Hold occurred at the detection point 455 when the image at the end point of the image sequence is displayed

S819 to S821 are the same as the processing steps of S517 to S519 respectively, hence description thereof is omitted.

FIG. 9 is a flow chart depicting details of the above mentioned Touch-Up processing in S813 of FIG. 8 according to Embodiment 2. This processing is implemented by the system control unit 50 developing a program, which is recorded in the non-volatile memory 56, in the system memory 52, and executing the program.

In S901, the system control unit 50 determines whether the continuous low-speed image switching was performed by the touch operation immediately before Touch-Up. In concrete terms, the system control unit 50 refers to the system memory 52, and determines whether the continuous low-speed image switching execution completion flag is recorded. Processing advances to S902 if the continuous low-speed image switching execution completion flag is recorded (continuous low-speed image switching was performed by the touch operation immediately before Touch-Up), or processing ends if not. After referring to the continuous low-speed image switching execution completion flag in S901, the system control unit 50 clears (initializes) the continuous low-speed image switching execution completion flag of the system memory 52.

In S902, the system control unit 50 determines whether the duration time of Touch-Hold immediately before Touch-Up (elapsed time from Touch-Hold to Touch-Up) reached a predetermined time (e.g. 3 seconds). In other words, this determines whether the continuous low-speed switching was performed at least for the predetermined time. Processing advances to S903 if the duration time of Touch-Hold was at least the predetermined time, or processing ends if not. Instead of determining whether the duration time of Touch-Hold reached the predetermined time, the processing in S902 may be determined whether a predetermined number (e.g. 6) of images were switched in the continuous low-speed image switching, that is, determination whether the display target was switched by a change amount of at least a predetermined number. In the case where at least a predetermined number of images were not switched in the continuous low-speed image switching, the user may have found a desired image after viewing a smaller number of images than the predetermined number that were switched, and if so, the user may no longer desire a faster image switching. The determination in S902 is performed for such a case, so as to prevent an unnecessary display of the function guidance to indicate the operation method of the continuous high-speed image switching. The processing may advance to S903 if the determination result in S901 is Yes, skipping the processing in S902, so that the function guidance is displayed if even one image is switched by continuous low-speed image switching, that is, if the display target is switched by a change amount of at least one.

Processing in S903 to S905 is the same as the above mentioned processing in S610 to S612, hence description thereof is omitted. In S904, the guidance to indicate the operation method for performing the continuous high-speed image switching (e.g. a guidance 700 in FIG. 7C) is displayed. The guidance 700 is displayed in a large size at an obvious location (center of screen), superimposed on the image switched by the continuous low-speed image switching. Further, the display content of the guidance 700 may not be text, but may be animation which helps the user to easily imagine how to perform a method. In this way, the user can more easily view the operation method to perform the continuous high-speed image switching. However, if such a guidance 700 is displayed in the middle of continuous low-speed image switching, it makes it difficult for the user to view the images and determine whether a desired image is displayed by switching or whether the continuous low-speed image switching should be ended. Therefore in Embodiment 2, the guidance 700 is not displayed in the duration period of Touch-Hold, that is, while the continuous low-speed image switching is in-execution, but is displayed at the timing of ending the continuous low-speed image switching, that is at Touch-Up. Thereby the user can recognize the operation method to perform the continuous high-speed image switching with certainty, without interruption of viewing an image during execution of the continuous low-speed image switching.

According to Embodiment 2, the user can recognize a different operation method (operation method of continuous high-speed image switching), which can efficiently change to an image ahead by several images (continuous high-speed image switching) with a large change amount, instead of image switching by the slide operation. In other words, even a user, who performs the continuous low-speed image switching by performing Touch-Hold on the edge of the touch bar 82, can recognize the operation method of the continuous high-speed image switching. The guidance is not displayed during the low-speed image switching, so that the image display switching is not interrupted, instead the guidance is displayed at the timing of Touch-Up, which does not interrupt the image display switching. If the guidance is displayed only when a predetermined condition is satisfied, as in the processing steps S901 to S903, guidance can be displayed in accordance with the intensions of the user.

It is assumed that the continuous image switching guide in a different display format (continuous image switching guide 330 in FIG. 3D) is displayed between the period when the continuous low-speed image switching is executed and the period when the continuous high-speed image switching is executed. For example, a motif of two arrow marks is displayed as the continuous image switching guide 330 in the case of the continuous low-speed image switching, and a motif of three arrow marks is displayed as the continuous image switching guide 330 in the case of the continuous high-speed image switching. Unlike the function guidance 700 that notifies that the continuous high-speed switching is performed, the continuous image switching guide 330 identifies that the continuous image switching is in-execution, and the direction of the continuous image switching and speed of the continuous image switching thereof. Thereby the user who instructed the continuous image switching after viewing the function guidance 700 can reconfirm that the operation method is correct (not the continuous low-speed image switching but the continuous high-speed image switching is in-execution).

An example of performing the continuous high-speed image switching by Touch-Hold after the slide operation was described, but a different action (function) that can change the display target image more efficiently (by a change amount larger than the maximum change amount which one slide operation can perform). For example, a predetermined number of (predetermined amount of) images may be switched (jumped) by Touch-Hold after the slide operation. For example, ten image-jumping, which switches the display target image to the tenth image ahead in each operation, or one hundred image-jumping, which switches the display target image to the one hundredth image ahead in each operation, are possible. The display target image may be switched to a predetermined image (predetermined change destination) by Touch-Hold after the sliding operation. For example, the currently reproducing moving image, which includes the chapter information, may be switched to the lead position of the chapter. Further, date jump may be performed by Touch-Hold after the slide operation, such as advancing the display target image to the first image of the images captured on the next image capturing date, or returning the display target image to the first image of the images captured on the same image capturing date. These actions allow switching the display target image to a desired image more efficiently than repeating one image switching (action of switching one image at a time) (in other words, the display target image can be changed by a change amount larger than that of a one-time slide operation.) The display target image may be switched by the low-seed scroll in the case of the continuous low-speed image switching, and the display target image may be switched by the high-speed scroll in the case of the continuous high-speed image switching. In other words, the scrolling speed may be changed between the case of Touch-Hold without the slide operation on the touch bar 82, and the case of Touch-Hold after the slide operation.

### Embodiment 3

Embodiment 1 and Embodiment 2 may be combined. In other words, in Embodiment 3, a function guidance is displayed when the slide operation, of which operation amount is larger than the first operation amount (A1), is repeated on the touch bar 82 for at least a predetermined number of times (N1). Further, the function guidance is also displayed at a timing when Touch-Up occurred after image switching was performed by Touch-Hold without the slide operation.

Details on the reproduction mode processing performed by the digital camera 100 in Embodiment 3 are the same as those described in FIG. 8. The hardware configuration of the digital camera 100 is the same as that described with reference to FIGS. 1A, 1B, 2, 4A and 4B. This processing is implemented by the system control unit 50 developing a program, which is recorded in the non-volatile memory 56, in the system memory 52, and executing the program. In Embodiment 3, the count values n and m and Time are used. Therefore in S501, the count values n, m and Time are initialized, and the processing steps S504 and S505 are also executed without skipping. The Touch-Up processing in S813 according to Embodiment 3 will be described with reference to FIG. 10.

FIG. 10 is a flow chart depicting details of the Touch-Up processing according to Embodiment 3. This processing is implemented by the system control unit 50 developing a program, which is recorded in the non-volatile memory 56, in the system memory 52, and executing the program. In the processing in FIG. 10, a processing step the same as the above mentioned FIG. 6 is denoted with the same step number as FIG. 6, and description thereof is omitted.

In S1001, just like S901, the system control unit 50 determines whether the continuous low-speed image switching was performed by the touch operation immediately before Touch-Up. Processing advances to S1002 if the continuous low-speed image switching was performed by the touch operation immediately before Touch-Up, or processing ends if not. The system control unit 50 refers to the continuous low-speed image switching execution completion flag in S1001, and clears (initializes) the continuous low-speed image switching execution completion flag of the system memory 52.

In S1002, just like S902, the system control unit 50 determines whether the duration time of Touch-Hold immediately before Touch-Up (elapsed time from Touch-Hold to Touch-Up) reached a predetermined time (e.g. 3 seconds). Processing advances to S610 if the duration time of Touch-Hold was at least the predetermined time, or processing ends if not. The processing in S1002 may be skipped, so that processing advances to S610 if the determination result is S1001 is Yes, and the function guidance is displayed if even one image is switched by the continuous low-speed image switching.

While the present invention has been described with reference to the preferred embodiments, the present invention is not limited to these specific embodiments, and includes various modes within the scope that does not depart from the essence of the invention. Each of the above mentioned embodiments is merely an example of the invention, and may be combined as required.

In the above description, various controls mentioned above are performed by the system control unit 50, but may be performed by one hardware component or by a plurality of hardware components (e.g. a plurality of processors and circuits) which share the processing to control the entire apparatus. In the above embodiments, a case of applying the present invention to the digital camera (imaging apparatus) was described as an example, but the present invention is not limited to this, but is applicable to any electronic apparatus of which operation can be detected. For example, the present invention is applicable to a personal computer, PDA, portable telephone terminal, portable image viewer, printer, digital photo frame, music player, game machine, electronic book reader and video player. The present invention is also applicable to a display apparatus (including a projection apparatus), tablet terminal, smartphone, AI speaker, home electronic equipment, on-vehicle apparatus and medical equipment.

According to this disclosure, the guidance to effectively change the change target can be displayed at a more appropriate timing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-123725, filed on Jul. 2, 2019, and Japanese Patent Application No. 2020-045994, filed on Mar. 17, 2020, which are hereby incorporated by reference herein in their entirety.

What is claimed is:

1. An electronic apparatus comprising at least one memory and at least one processor which function as:
an operation detection unit configured to detect an operation on an operation member; and
a display control unit configured to perform control so as to
execute a first action to continuously change a display target displayed on a display when a specific type of operation on the operation member is detected,
execute a second action which is one of: an action to continuously change the display target at a higher speed than the first action: an action to change the display target by a predetermined amount larger than a change amount by a one-time execution of the first action; and an action to change the display target to a predetermined change destination, when a second type of operation on the operation member is detected, and
display a guidance for the second type of operation at the end of the specific type of operation in a case where the specific type of operation is detected and a predetermined condition is satisfied.

2. The electronic apparatus according to claim 1, wherein the case where a predetermined condition is satisfied is a case where the display target is changed by a change amount of at least one by the first action.

3. The electronic apparatus according to claim 1, wherein the case where a predetermined condition is satisfied is a case where a duration time of the first action reached at least a predetermined time, or a case where the display target is changed by a change amount of at least a predetermined number by the first action.

4. The electronic apparatus according to claim 1,
wherein the operation member is an operation member capable of a touch operation, and
the operation detection unit detects the touch operation on an operation surface of the operation member.

5. The electronic apparatus according to claim 4, wherein the specific type of operation is an operation of starting touch at a predetermined position on the operation surface and continuing a touched state without a slide operation for at least a predetermined time.

6. The electronic apparatus according to claim 5, wherein the predetermined position is an edge portion of the operation surface in a direction capable of the slide operation.

7. The electronic apparatus according to claim 4, wherein the second type of operation is an operation of performing a slide operation after touch on the operation surface is started, and continuing the touch without releasing in a state of stopping the slide operation for at least a predetermined time.

8. The electronic apparatus according to claim 1, wherein the guidance indicates an operation method of the second type of operation.

9. The electronic apparatus according to claim 8, wherein, for the guidance, the operation method of the second type of operation is displayed using animation.

10. The electronic apparatus according to claim 1, wherein the guidance is displayed superimposed on the display target.

11. A control method of an electronic apparatus, comprising:
detecting an operation on an operation member; and
performing control so as to
execute a first action to continuously change a display target displayed on a display when a specific type of operation on the operation member is detected,
execute a second action which is one of: an action to continuously change the display target at a higher speed than the first action; an action to change the display target by a predetermined amount larger than a change amount by a one-time execution of the first action; and an action to change the display target to a predetermined change destination, when a second type of operation on the operation member is detected, and
display a guidance for the second type of operation at the end of the specific type of operation in a case where the specific type of operation is detected and a predetermined condition is satisfied.

12. An electronic apparatus comprising at least one memory and at least one processor which function as:
an operation detection unit configured to detect an operation on an operation member;
a control unit configured to perform control so as to execute a first action to change a specific change target in accordance with an operation amount of a first type of operation when the first type of operation on the operation member is detected by the operation detection unit, and to execute a second action which is one of an action to continuously change the specific change target; an action to change the specific change target by a predetermined amount larger than a change amount by a one-time execution of the first action; and an action to change the specific change target to a predetermined change destination; and
a display control unit configured to perform control so as to display a first guidance for the second action when the first type of operation of which an operation amount is at least a first operation amount, corresponding to an operation to instruct a change with a change amount larger than a minimum unit of change amount which is changeable by the first type of operation, is repeated for a first number of times that is a plurality of times.

13. The electronic apparatus according to claim 12, wherein
the display control unit performs control so as to also display the first guidance in a case where the first type of operation of which an operation amount is at least a second operation amount, corresponding to an operation to instruct a change of which a change amount is smaller than the first operation amount and is larger than the minimum unit of the change amount, is repeated for a second number of times which is more than the first number of times.

14. The electronic apparatus according to claim 12, wherein
the display control unit perform control so that
in a case where the first type of operation of which an operation amount is at least the first operation amount is not performed for the first number of times within a predetermined period, the first guidance is not displayed even when the first type of operation of which an operation amount is at least the first operation amount is performed for the first number of times, and
the first guidance is displayed when the first type of operation of which an operation amount is at least the first operation amount is performed for the first number of times within the predetermined period.

15. The electronic apparatus according to claim 12, wherein the operation member is a touch operation member.

16. The electronic apparatus according to claim 15, wherein
the first type of operation is an operation of touching the touch operation member and moving a touch position, and
the second type of operation is an operation of continuing touch on the touch operation member.

17. The electronic apparatus according to claim 12, wherein the operation member is a rotational operation member.

18. The electronic apparatus according to claim 12, wherein the first action is an action of switching an image to be displayed among a plurality of images by a switching amount in accordance with the operation amount of the first type of operation.

19. The electronic apparatus according to claim 12, wherein when the second action is executed, the display control unit perform control so as to display a second guidance, which is different from the first guidance, for the second action.

20. The electronic apparatus according to claim 19, wherein
both the first action and the second action are actions to switch an image to be displayed among a plurality of images, and
the second guidance is an item identifiable a switching direction of the image to be displayed in the second action.

21. The electronic apparatus according to claim 12, wherein after the first guidance is displayed, the display control unit perform control so that the first guidance is not displayed, even when the first type of operation of which an operation amount is at least the first operation amount is performed for the first number of times, until a change screen of the specific change target ends.

22. The electronic apparatus according to claim 12, wherein the specific change target is an image to be displayed.

23. The electronic apparatus according to claim 12, wherein the specific change target is a specific parameter.

24. The electronic apparatus according to claim 23, wherein the specific parameter is any one of an image capturing parameter, image processing parameter, sound volume, date, time and seconds.

25. A control method of an electronic apparatus, comprising:
detecting an operation on an operation member;
performing control so as to execute a first action to change a specific change target in accordance with an operation amount of a first type of operation when the first type of operation on the operation member is detected, and to execute a second action which is one of an action to continuously change the specific change target; an action to change the specific change target by a predetermined amount larger than a change amount by a one-time execution of the first action; and an action to change the specific change target to a predetermined change destination; and
performing control so as to display a first guidance for the second action when the first type of operation of which an operation amount is at least a first operation amount, corresponding to an operation to instruct a change with a change amount larger than a minimum unit of change amount which is changeable by the first type of operation, is repeated for a first number of times that is a plurality of times.

26. A non-transitory computer readable medium that stores a program, wherein the program causes a computer to execute a control method of an electronic apparatus, the control method comprising:
detecting an operation on an operation member; and
performing control so as to
execute a first action to continuously change a display target displayed on a display when a specific type of operation on the operation member is detected,
execute a second action which is one of: an action to continuously change the display target at a higher speed than the first action; an action to change the display target by a predetermined amount larger than a change amount by a one-time execution of the first action; and an action to change the display target to a predetermined change destination, when a second type of operation on the operation member is detected, and
display a guidance for the second type of operation at the end of the specific type of operation in a case where the specific type of operation is detected and a predetermined condition is satisfied.

27. A non-transitory computer readable medium that stores a program, wherein the program causes a computer to execute a control method of an electronic apparatus, the control method comprising:
detecting an operation on an operation member;
performing control so as to execute a first action to change a specific change target in accordance with an operation amount of a first type of operation when the first type of operation on the operation member is detected, and to execute a second action which is one of an action to continuously change the specific change target; an action to change the specific change target by a predetermined amount larger than a change amount by a one-time execution of the first action; and an action to change the specific change target to a predetermined change destination; and
performing control so as to display a first guidance for the second action when the first type of operation of which an operation amount is at least a first operation amount, corresponding to an operation to instruct a change with a change amount larger than a minimum unit of change amount which is changeable by the first type of operation, is repeated for a first number of times that is a plurality of times.
